(19) United States
(12) Patent Application Publication
(10) Pub. No.: US 2026/0330125 A1
(43) Pub. Date: Oct. 22, 2026

(54) Multi-Agent AI Systems for Document Creation

(71) Applicant: KPMG International Services Ltd, London (GB)

(72) Inventors: Martin Herbert, Glasgow (GB); Patrice Dupont-Roc, Sydney (AU)

(73) Assignee: KPMG International Services Ltd, London (GB)

(21) Appl. No.: 19/182,995

(22) Filed: Apr. 18, 2025

(51) Int. Cl. G06F 40/166; G06F 16/34; G06F 21/62; G06F 40/253; G06F 40/295; G06F 40/58

(52) U.S. Cl. CPC G06F 40/166; G06F 16/345; G06F 21/6254; G06F 40/253; G06F 40/295; G06F 40/58

(57) ABSTRACT

Systems and methods for generating documents using multiple artificial intelligence (AI) agents. A method includes ingesting and summarizing content from existing files using a file analyzer agent, generating a draft document based on the summarized content using a document writer agent, refining the draft document to align with brand tone and visual style guides using a brand tone and visual agent, editing the draft document for grammatical accuracy and clarity using an editor agent, detecting and mitigating biases in the draft document using a bias detector agent, and coordinating the activities of the AI agents using an orchestrator device.

### BACKGROUND OF THE INVENTION

There is currently no single, consistent approach, format, storage location, or straightforward way of creating and selecting credentials globally, and of telling relatable client delivery stories in a compelling way. Although compilation of customer stories into credentials is the first instance of use, the invention is not limited to these documents and can be made to generate any sort of document for which consistency in voice, branding, and content is desired.

Generally, known attempts to resolve this issue are based on manual processes. For example, drafting of documents, such as customer success stories (also known as “credentials”), is currently manual and so takes on unique author voices or, even if done using AI, is subject to differences in prompting techniques. Template documents can be useful but are subject to spacing constraints and differences in version and locale. Accordingly, current processes are time consuming and take away from business development and client service activities. Creating quality credentials is a time-consuming task, often taking place after an engagement has finished when our people have emotionally moved on to their next project. Moreover, manual processes are inconsistent in that credentials and case studies vary in format, length, and tone, with inconsistent information being conveyed, and thus are often non-complaint with an organization's brand guidelines. Further, manually created documents are often not sharable because they must first be approved for sharing outside of the originating project team and between entities.

### SUMMARY OF THE INVENTION

The present invention relates to systems and methods for generating documents using multiple headless agents that operate in sequence or are called in an agentic manner by an orchestrator agent. The system is designed to enhance the efficiency, consistency, and compliance of document creation processes by leveraging the capabilities of various specialized agents in a collaborative manner to produce high-quality documents without the need for individual interfaces.

In one embodiment, a method includes ingesting and summarizing content from existing files using a file analyzer agent, generating a draft document based on the summarized content using a document writer agent, refining the draft document to align with brand tone and visual style guides using a brand tone and visual agent, editing the draft document for grammatical accuracy and clarity using an editor agent, detecting and mitigating biases in the draft document using a bias detector agent, and coordinating the activities of the AI agents using an orchestrator device.

In another embodiment, a system includes an AI model, a plurality of AI agents stored in an AI agent library, an orchestrator device, and one or more agent devices. The plurality of AI agents is configured to interact with the AI model to generate documents and includes a file analyzer agent configured to ingest and summarize content from existing files, a document writer agent configured to generate a draft document based on the summarized content, a brand tone and visual agent configured to refine the draft document to align with brand tone and visual style guides, an editor agent configured to edit the draft document for grammatical accuracy and clarity, and a bias detector agent configured to detect and mitigate biases in the draft document. The orchestrator device is configured to coordinate the activities of the AI agents and includes a content creation module for generating and refining document content, a decision support module for guiding the approval process, an information retrieval module for ingesting and summarizing content from existing files, an automation module for performing automated services such as translation and anonymization, and a communications device for facilitating communication between the orchestrator device, AI agents, and user computing devices. The agent devices include a processor for executing instructions, short-term memory for storing program instructions and data generated during execution, long-term memory for storing data and applications, an input module for accepting data as parameters, and an output module for delivering data as a result of execution.

In another embodiment, a system includes an orchestrator device communicatively coupled to one or more user computing devices via a network. The orchestrator device includes a content creation module configured to generate and refine document content, a decision support module configured to guide the approval process of the generated document, an information retrieval module configured to ingest and summarize content from existing files, an automation module configured to perform automated services such as translation and anonymization, and an orchestrator module configured to coordinate the activities of the AI agents. The orchestrator module includes a task planning unit for planning tasks and assigning subtasks to the AI agents, a progress monitoring unit for monitoring the progress of the tasks performed by the AI agents, and an error recovery unit for recovering from errors encountered during the execution of tasks by the AI agents.

### BRIEF DESCRIPTION OF DRAWINGS

The present invention is described by way of example and not limited to the accompanying figures in which like reference numbers indicate similar elements and in which:

FIG. 1 is a diagram of an exemplary system for using a series of AI agents to generate a document;

FIG. 2 is a logical architecture of the modules shown in FIG. 1;

FIG. 3 is a flowchart illustrating an exemplary method of generating a document using a series of AI agents; and

FIG. 4 is a block diagram of an example device or system upon which any of the techniques and processes discussed herein may be performed.

### DETAILED DESCRIPTION OF THE INVENTION

The invention includes a series of headless agents, each assigned specific roles and functions. Embodiments of the invention address a significant challenge in the creation and selection of documents for use across a large organization. Currently, there is no single, consistent approach, format, or storage location for creating and selecting such documents that is not manually driven. This lack of consistency leads to documents that vary in format, length, tone, and content, often resulting in non-compliance with brand guidelines. Additionally, the manual process of drafting such documents is time-consuming, taking away from business development and client service activities. This process often occurs after an engagement has finished, when team members have emotionally moved on to their next project, leading to incomplete or inconsistent documentation of client delivery stories, for example.

Thus, embodiments of the invention provide systems and methods that leverage multiple artificial intelligence (AI) agents to create documents with consistent voice, branding, and content. These AI agents can operate individually or collaboratively within multi-agent systems to solve complex problems. The process involves creating advanced decision-making frameworks, ethical reasoning, and adaptability. The invention chains multiple agents to act as an assistant that enables and accelerates the creation of quality, impactful credentials; the searching and retrieval of credentials for use in, e.g., request for proposal (RFP) and pitch responses); and the reporting and analytics related to client delivery stories globally.

The invention's architecture includes several key components, each represented by a specific AI agent. For example, a file analyzer agent processes existing documents using an AI model, such as a machine learning model, large language model (LLM), or other transformer model, to index and analyze them as the basis for the credential. This agent navigates ingested files, summarizing them for further use. The ingested files may include, for example and not by way of limitation, Microsoft Word files, Adobe PDF files, Microsoft PowerPoint files, or any other suitable file for providing information related to a desired type of document end product. As another example, a writing agent generates a draft document after related documents are found and processed by the file analyzer agent and, also after an end user completes a question-and-answer process. This agent shows the user a preview of the document with similar formatting and allows the user to download the draft document in its final format.

A translator agent translates text and documents, while anonymizer agent recognizes named entities and replaces them with anonymized descriptors. A brand tone and visual agent analyzes and refines content for alignment to brand tone of voice and visual guidance. An audience experience agent performs relevance and value analysis, refines tone and vocabulary, and updates text for greater audience impact and resonance. An editor agent edits text, checks grammar, and rephrases content to ensure clarity and polish. A reviewer agent compares draft output with requirements and runs compliance checks. Finally, an approver agent defines reviewers and initiates notifications, renewing approval when expired.

An agentic orchestrator coordinates multiple agents to solve complex problems by chaining them together to act as an assistant. This orchestrator leads the overall process, plans tasks, assigns subtasks, monitors progress, and recovers errors.

The use of multiple AI agents to generate documents with desired tone, branding, and content is a novel development. Traditionally, this process has been done manually, leading to inconsistencies and inefficiencies. The invention provides speed, accuracy, consistency, and shareability, making it a significant improvement over existing solutions.

An addition, embodiments of the invention allow for simultaneous performance of multiple agents. For example, the file analyzer agent can process existing documents while the writing agent generates a draft document. The agentic orchestrator ensures that these agents work together efficiently and accurately. Additionally, not all agents are necessary for every document being created. For instance, if there is no need for translation, the translator agent can be skipped. Similarly, if there is no audio component to the final document, the audio analysis can be skipped.

The invention offers several advantages over prior existing technology. The use of AI agents removes the manual aspects of drafting, creating documents using preexisting documents and/or interview questions. This approach is generally faster and more accurate than manual drafting. Additionally, the use of AI agents ensures consistency in tone, terminology, references to other projects, and branding, which is often lacking in manually drafted documents.

The workflow of the system involves the agents working in sequence to generate a document. In an embodiment, the process begins with a designer agent generating the initial visual content and formatting the document. An editor agent then edits the text, checks for grammatical errors, and rephrases content as needed. A reviewer agent subsequently reviews the draft, comparing it with the requirements and running compliance checks. If translation is required, a translator agent translates the text into the desired language. Throughout this process, a brand compliance agent continuously monitors the document to ensure adherence to brand guidelines and regulatory standards.

The agents interact with each other through a coordinated workflow managed by the reviewer agent, which may act as an orchestrator. For example, after the designer agent completes the visual content, the editor agent is triggered to refine the text. Once the text is edited, the reviewer agent reviews the draft and may request further edits or compliance checks from the compliance agent. If the document needs translation, the translator agent is activated to translate the content. An anonymizer agent may be called upon to anonymize sensitive information before the final review. An approver agent manages the approval process by defining reviewers, initiating notifications, and renewing approvals when necessary. It interacts with a reviewer agent to ensure that all required approvals are obtained before the document is finalized. An audio processor agent facilitates conversations with users, capturing and transcribing information that may be used by other agents to refine the document. For instance, insights gathered by the audio processor agent can be used by an audience experience agent to enhance the emotional appeal of the content. A file analyzer agent processes ingested files and creates summaries that can be used by a writer agent to generate structured content. A search agent retrieves and summarizes credentials narratives, which are then enriched by a business research agent with relevant internet search results.

One aspect of the systems and methods described here is the mechanism for selectively activating agents based on user input or decisions made by an AI model. Users can interact with the system to choose which agents to activate, depending on the specific requirements of the document to be generated. For example, a user may decide to activate the designer agent to generate visual content, followed by the editor agent to refine the text. If the user requires translation, they can activate the translator agent. User input may also influence the sequence and interaction of agents. For instance, if a user provides specific guidelines for brand compliance, the compliance agent will prioritize those guidelines during the document creation process. Similarly, if a user requests anonymization of sensitive information, the anonymizer agent will be activated to replace named entities with anonymized descriptors. Alternatively, the AI model can autonomously decide which agents to activate based on the document's needs, further streamlining the process and reducing the need for user intervention. For example, the AI model may analyze the document's requirements and activates the appropriate agents in the optimal sequence to achieve the desired outcome.

The invention uses AI to perform many of the novel aspects described herein. The invention may use one or more AI models to perform various steps and, thus, does not simply automate steps of a manual process using general purpose computers. Rather, the invention requires multiple agents to use AI in a chained fashion to automatically generate and modify a document in a specific order based on the document contents, audience, and brand guidance or policy. Moreover, the invention uses AI to propose initial text, modify text, and insert diagrams or other visuals.

These functions have traditionally been done using a manual process, depending on a computer system only for general word processing and similar functions. Notably, the information input into the systems and methods is stored and can be later used for fine tuning the AI model, acting as a feedback mechanism. In addition, the output generated by the AI model is also stored for similar feedback usage. Moreover, the output generated by the AI model one process of the overall method is used as input into one or more other processes of the method. There is currently no way to provide such functionalities through a single system because of the limitations of known systems in respect of digesting and using information spread across a network or the entirety of the internet. Furthermore, embodiments of the invention improve standard computer systems when used for document generation, as those systems are unable to automatically transform disparate types of data into formats usable for their algorithms. The invention enables the use of AI model to provide this functionality.

### System Architecture

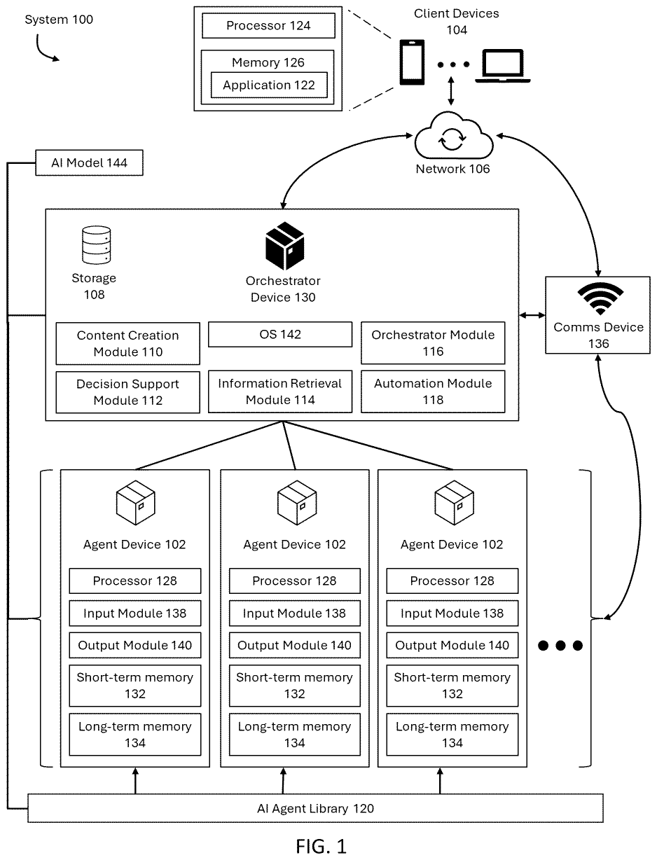

FIG. 1 is a diagram of an exemplary system 100 for using a series of AI agents to generate a desired document that includes selected tone/voice, content, and/or branding. As shown in FIG. 1, the system 100 may include one or more agent devices 102 and one or more users associated with one or more user client computing devices 104, all interconnected and communicatively coupled through a network 106. The orchestrator device 130 triggers the agent devices 102 either when users request it or when the orchestrator module 116, decision support module 112 and automation module 118 determine it is necessary. The orchestrator device 130 may also include a content creation module 110 and information retrieval module 114.

The client devices 104 may access via the network 106 an application interface or website (e.g., client application 122) hosted by the orchestrator device 130. The client devices 104 may call one or more active programming interfaces of the orchestrator device 130 using the application interface to provide, e.g., a user identifier, a document type to generate, an audience of the document to be generated, branding requirements, and/or the voice or tone of the document to be generated. The client devices 104 may also receive questions and send answers to the questions for document setup parameters via the application interface. Although the client devices 104 shown in FIG. 1 are illustrative and shown as a mobile device and a laptop, the client devices 104 may be any suitable type of computing device including, but not limited to, desktop personal computers, laptops, mobile phones, smartphones, personal digital assistants, tablets, game consoles, set-top boxes, wearable computers (e.g., watches or glasses), e-readers, web-enabled televisions, and the like. In certain aspects, the client devices 104 may include touch screen capabilities, motion tracking capabilities, cameras, microphones, vision tracking, etc. Moreover, to accommodate these capabilities, the client devices 104 may include one or more processors 124 and memory 126 to store data and applications, such as application 122.

The orchestrator device 130 may be any suitable device such as a cloud computing device or server running an operating system 142 and application programs or modules for implementing the features disclosed herein, including the content creation module 110, decision support module 112, information retrieval module 114, orchestrator module 116, and automation module 118. The various modules may be in communication with the client devices 104 via the communications device 136 and the network 106. The orchestrator device 130 may include one or more servers arranged in a cluster, as a server farm, or the like, and may be configured to host one or more websites such as the client application 122 accessible by means known in the art, such as via a web browser or application.

Each agent device 102 includes one or more processors 128, short-term memory 132 and long-term memory 134. The processor 128 may be implemented in hardware, software, firmware, or any combination thereof. Software or firmware implementations of the processor 128 may include computer-executable or machine-executable instructions written in any suitable programming language to perform the various functions described herein.

The short-term memory 132 may store program instructions that are loadable and executable by the processor 128, as well as data generated during the execution of these programs. Depending on the configuration of the agent device 102, the short-term memory 132 may be volatile, such as random-access memory (RAM), and/or non-volatile, such as read-only memory (ROM), flash memory, etc. The agent device 102 may also include additional long-term memory 134, but not limited to structured blob or file storage, unstructured blob or file storage, relational database, and vector database. The short-term memory 132 and long-term memory 134 are examples of computer-readable storage media. For example, computer-readable storage media may include volatile and non-volatile, removable and non-removable media implemented in any method of technology for the storage of information such as computer-readable instructions, data structures, program modules, or other data.

The communications device 136 allows the orchestrator device 130 and agent devices 102 to communicate with the client devices 104 via the network 106. The agent devices 102 may also include input module 138 for accepting texts, images, sounds, or any other forms of data as parameters, and output module 140 for delivering texts, images, sounds, or any other forms of data as a result of execution.

The orchestrator device 130, agent devices 102, and AI agent library 120 may include an AI model 144 that uses algorithms to orchestrate tasks or create new content based on patterns and structures learned from existing data. The AI model 144 can generate coding scripts, text, images, videos, and other forms of data by understanding the underlying relationships within data used for training. For example, generative AI models like GPT-4 and DALL-E can produce human-like text and realistic images, respectively. These models have a wide range of applications, including programming code generation, content creation, data augmentation, and enhancing user experiences across various industries. The AI model 144 is shown connected to the orchestrator device 130, agent devices 102 and AI agent library 120 but may alternatively be communicatively coupled to the client devices 104 via the network 106. The AI model 144 works by analyzing large datasets to learn patterns and structures within the data. For example, the AI model 144 may use neural networks to process and generate new content that mirrors human expression. The neural networks consist of multiple layers of interconnected neurons that process and transmit information, where each layer serves a specific purpose in processing information. During training, the AI model 144 is exposed to vast amounts of data, allowing it to learn and improve its ability to generate contextually relevant and coherent outputs. Once trained, the AI model 144 can create programming code, text, images, code, and other forms of content based on the learned patterns. This process involves predicting the next word or pixel in a sequence, ensuring the generated content is consistent with the input data.

The AI agent library 120 includes the software systems or programs that are run by the orchestrator device 130 and agent devices 102. When run by the agent devices 102, the software systems or programs use the data gathered by the input module 138 to perform self-determined tasks and deliver result data through the output module 140, storing intermediary data needed to execute the tasks in the short-term memory 132 and long-term memory 134. When run by the orchestrator device 130, the software systems or programs use a similar mechanism to collect data as inputs and produce data as outputs, using storage 108 as long-term memory.

### Logical Architecture

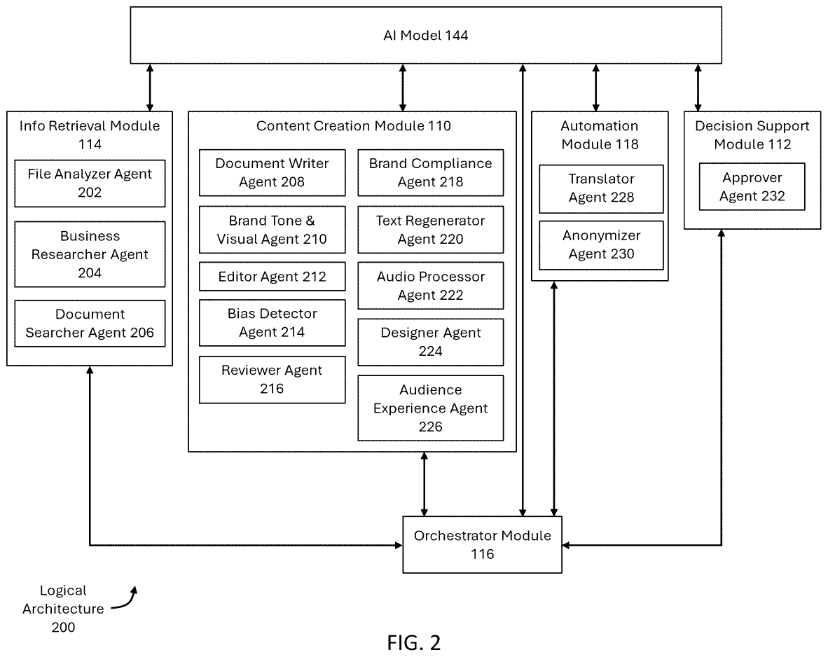

FIG. 2 is a logical architecture 200 of AI agent library 120 shown in FIG. 1. The agent library 120 may include one or more agents in the form of software systems or programs that use an AI model to autonomously pursue goals and complete tasks on behalf of users or other systems, showing reasoning, planning, and memory, and having the ability to learn and adapt. Agents are like layers on top of the AI model that observe and collect information, provide input to the model and together generate an action plan and communicate that to a user, or even act on their own, if permitted. The agents described herein may be any type of agent, including reflex agents, learning agents, utility-based agents, hierarchical agents, and the like, but in general the agents described herein are goal-based agents, meaning that they are designed to pursue specific objectives.

The information retrieval module 114 enables file upload, such as from a client device 104 (shown in FIG. 1) or retrieval from outside of the system 100 of FIG. 1, such as via an API from an external server, as well as research services, and search services. The information retrieval module 114 may include a file analyzer agent 202, a business researcher agent 204, and a document searcher agent 206. The file analyzer agent 202 receives binary inputs (e.g., files), navigates the ingested files, and summarizes them for future use using by interacting with the AI model 144. The ingested files may be any suitable type of file that provides information for use in the processes described herein, including but not limited to PDF files, word processing documents (e.g., Microsoft Word or Google Docs files), spreadsheets (e.g., Microsoft Excel or Google Sheets files), presentations (e.g., Microsoft PowerPoint or Google Slides files), images (e.g., JPEG files). The file analyzer agent 202 may use a static prompt to the AI model 144 in a consistent manner. The business researcher agent 204 receives text input, conducts internet searches based on the text, and enriches a generated document with the results (i.e., outputs text). For example, the business researcher agent 204 may use static prompting to prompt the AI model 144 to conduct an internet search for a business that is the topic of the generated document. The document searcher agent 206 receives structured data as input (e.g., document status, country, industry, etc.), performs searches within a network based on the input data, and returns narratives that may be used in a generated document in the form of structured data. The search results from the business researcher agent 204 and the document searcher agent 206 may be analyzed by the AI model and returned to the proper agent 204 or 206 in a format usable in the generated document type.

The content creation module 110 receives information from the information retrieval module 114 and interacts with the AI model to generate a requested document that complies with specified requirements such as brand, tone, audience, formatting, etc. The content creation module 110 may also interact with the AI model to edit the document, detect bias, revise content and formatting of the document, and add non-visual properties to the document such as audio. The content creation module 110 may include a number of agents including a document writer agent 208, a brand tone and visual agent (brand agent) 210, an editor agent 212, a bias detector agent 214, a reviewer agent 216, a brand compliance agent 218, a text regenerator agent 220, an audio processor agent 222, a designer agent 224, and an audience experience agent 226.

The document writer agent 208 receives ingested information from the file analyzer agent 202 in the form of a database vector and prompts the AI model 144 using a least-to-most prompting strategy to generate drafts of the requested document based on that information.

The information could include an industry focus for services provided, a technology focus such as those used to create a deliverable, customer feedback, etc. The brand agent 210 receives text (e.g., the document), and analyzes and refines content in the generated document to ensure alignment with brand, tone of voice, and visual guidance or policy. For example, there may be a guidance requiring active voice versus passive voice. To ensure alignment, the AI model 144 may ingest brand guidance or policy and the brand agent 210 may generate a prompt via dynamic prompt injection to check the generated document against the specific guidance or policy. The editor agent 212 edits the document text and checks grammar and rephrases content to ensure clarity and completeness. For example, the editor agent 212 may create a prompt via dynamic prompt injection to the AI model 144 that requests grammar and spelling checks in a referred document and for the AI model 144 to propose changes to the document.

The bias detector agent 214 conducts ethical reviews of generated documents to detect bias and provides alternative words or phrases. For example, the bias detector agent 214 may prompt the AI model 144 to analyze the document to recognize known biases, which the AI model 144 learned as part of its training process (e.g., adversarial training, where the model is trained to recognize and mitigate biases by exposing it to known biased and unbiased samples). The brand compliance agent 218 analyzes the document and provides alternative phrases to adhere with brand compliance guidelines. For example, the brand compliance agent 218 may prompt the AI model 144 to analyze the document to recognize passive or negative grammatical construction and request modifications to ensure the syntax used conveys an active and positive tone of voice. The reviewer agent 216 monitors the tasks run by other agents against a draft of the document and suggests changes for compliance. For example, the reviewer agent 216 may prompt the AI model 144 to analyze the output of other agents to assess whether the document has reached a satisfactory standard based on predetermined guidelines.

The text regenerator agent 220 edits, resizes, and rephrases text to ensure clarity and impact by ensuring the document fits within a desired wordcount or character count, either of which may be dictated by policy, document sizing rules, or by user specifications. For example, the text regenerator agent 220 may prompt the AI model 144 to analyze the document in reference to specified rules and request that the AI model 144 suggest modifications to the document to ensure compliance with those specified rules. The audio processor agent 222 summarizes information and interacts in conversations. For example, the audio processor agent 222 may ingest audio files such as interviews or news reports and prompt the AI model 144 to analyze the audio files and output text and/or incorporate relevant text into the document.

The designer agent 224 generates visual content and formats the document. For example, the designer agent 224 may prompt the AI model 144 to suggest design changes to the document such as positioning of text blocks or visuals, visual sizing, banner size and position, etc. The audience experience agent 226 performs relevance and value analyses, refines the tone and vocabulary of the document, and updates the document for better audience impact and resonance. For example, the audience experience agent 226 may prompt the AI model 144 to analyze the document for an audience specified in the prompt, which may be based on policy or received from a user, and the AI model 144 may propose changes to the document that better reflects the intended audience's makeup, demographics, position in an organization hierarchy, etc.

The automation module 118 provides automated services for a document such as translation between languages and anonymization, which may include deidentifying people and/or organizations from the document. The automation module 118 may include a translator agent 228 and an anonymizer agent 230. The translator agent 228 translates the document from one language into a second identified language. For example, the translator agent 228 may prompt the AI model 144 to analyze the document in a first language, which may be identified by the translator agent 228 or may be identified by the AI model 144 at the direction of the translator agent 228, into a second language identified by the translator agent 228 in its prompt. The second language may be automatically assigned based on policy, wherein all documents must be generated in both English and French, or may be received via user input. The anonymizer agent 230 recognizes named entities and replaces them with anonymized descriptors. For example, the anonymizer agent 230 may refer the AI model 144 to a list of entities (e.g., company names, countries, governmental entities, etc.) and instruct the AI model 144 to replace recognized entity names in the document with alternative descriptors, e.g., a generic industry descriptor of a given company. Moreover, the anonymizer agent 230 may instruct the AI model 144 to recognize personally identifying information and instruct the AI model 144 to replace that information with alternative language.

The decision support module 112 guides the approval process of a document after it has been drafted and edited using other agents. The decision support module 112 may include an approver agent 232 that defines reviewers, initiates notifications to the reviewers, and tracks approvals. For example, the approver agent 232 may refer the AI model 144 to a list of approvers (e.g., specific names or positions for approvers) and instruct the AI model 144 to determine the proper approvers based on the contents of the document and to draft notification emails or other notices to the approvers. The approver agent 232 may then send notifications to the identified approvers including the language obtained from the AI model 144.

As shown in FIG. 2, all the modules and agents interact with the orchestrator module 116, and the AI model 144.

Although the modules are shown as including certain agents, it should be understood that the agents may be contained within other modules or as separate modules. In addition, the grouping of the agents does not affect the order of operation of any given agent in the processes described herein.

### Process Flowchart

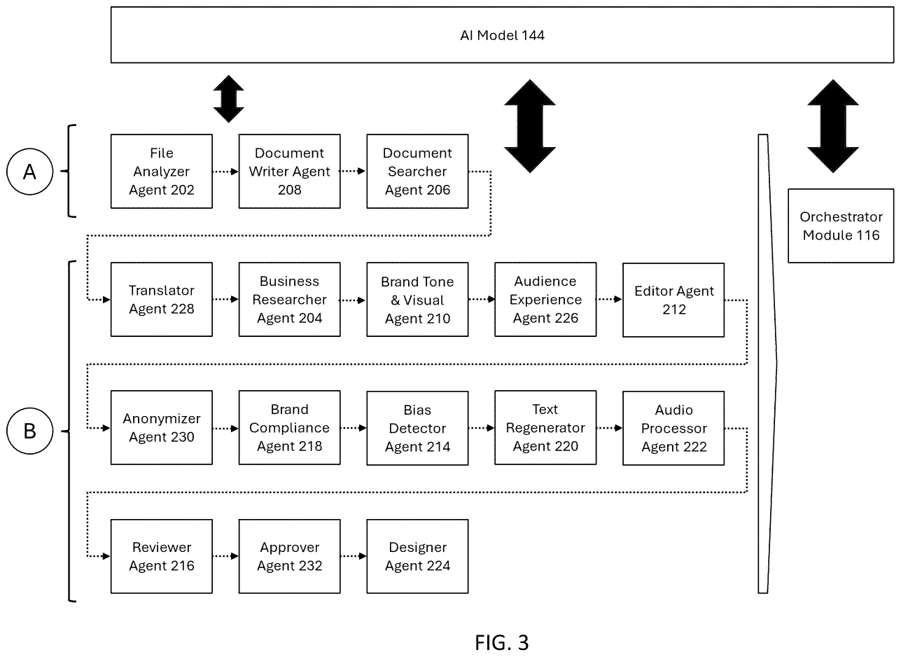

FIG. 3 is a flowchart 300 illustrating an exemplary method of generating a document using a series of AI agents. Initially, in an embodiment, some agents are specific to the processes described herein, as shown by the letter A in FIG. 3, whereas other agents are generic and may be used in other processes not described and as shown by the letter B in FIG. 3. In alternative embodiments the agents are all generic or all specific, or the groups indicated by letters A and B are changed.

In one embodiment, the file analyzer agent 202 interacts with the AI model 144 to ingest and summarize the content of files. The files may be specified by a user using, for example, a checklist of existing documents or may be uploaded by the user via application 122 (shown in FIG. 1). The file analyzer agent 202 reads in a list of files to ingest and calls a blob storage API to save the files into storage 108. The files are stored in, but not limited to, structured blob or file storage, unstructured blob or file storage, relational database, or vector database, segregated into folders with unique identifiers. After ingesting the files, the file analyzer agent 202 processes the files. In an embodiment, the file analyzer agent 202 calls the anonymizer agent 230 to remove personally identifiable information from the extracted files. The file analyzer agent 202 also passes a folder name to, e.g., the AI model 144 as a reference of the file to be vectorized. After the vector has been generated, the file analyzer agent 202 runs a completion API to obtain a short summary for the file, which is recorded as blob metadata against the file's uniquely identified folder in storage 108. After ingesting and processing the identified files, the file analyzer agent 202 signals to the orchestrator module 116 that it has completed its process. The orchestrator module 116 then calls the document writer agent 208.

The document writer agent 208 interacts with the AI model 144 to generate a formatted document including content based on the content of the files ingested and summarized by the file analyzer agent 202. For example, the document writer agent 208 proceeds through a set of prompts in a prompt library and, for each prompt, calls on the AI model 144 to respond to the prompt. The response from the AI model 144 is added to a document under generation. The document writer agent 208 then signals to the orchestrator module 116 that it has completed its process. The orchestrator module 116 then calls the document searcher agent 206.

The document searcher agent 206 performs a search, such as an internet search or internal network search, for related or similar data and returns information. For example, the document searcher agent 206 may extract the following details describing the entities mentioned in the document (including, but not limited to, employees, products, customers, locations, companies or events): type of organization/industry sector, geographic location(s), size metrics (employees, revenue, customers, etc.), key operations, products, or services or any other unique or distinguishing features. Based on those key characteristics, it may generate 3-5 specific internet search queries that would help create a more concise and professional description of the entities. It may suggest modifications to the document to help convey its ideas and messages more accurately, reducing the risk of misunderstandings. The document searcher agent 206 then signals to the orchestrator module 116 that it has completed its process. The orchestrator module 116 then calls the translator agent 228.

The translator agent 228 interacts with the AI model 144 to translate the document into one or more languages. The steps following this are performed for each language of the document, whether serially or in parallel. For example, the translator agent 228 passes text strings in the first language and identifies the second language to the AI model 144. The AI model 144 processes and generates a matching text string in the second language as is known in the art and returns the matching text string to the translator agent 228. The translator agent 228 then signals to the orchestrator module 116 that it has completed its process and the orchestrator module 116 calls the business researcher agent 204.

The business researcher agent 204 interacts with the AI model 144 to create an internet search query based on the content of the document, summarize the internet search results, and merges the search results into the content of the document. In an embodiment, the business researcher agent 204 may, via a question-and-answer session with a user (e.g., via the client device application 122) gather information on the topic of the document. For example, if the document is related to a specific client engagement, the question-and-answer session may prompt the user to input the name of the client, location, event information, and/or product information. The business researcher agent 204 performs internet searches for each of these entities alone and/or in combinations such as location and client name or location and event. If a location cannot be determined or is left out of the information received from the user, the business researcher agent 204 performs internets searches only on, for example, the client name and product information. The business researcher agent 204 passes the search results to the AI model 144 in a prompt, including snippets of the top five (which is configurable) search results for each query. The AI model 144 replies with a suggested text that summarizes the set of snippets into a single paragraph or visual. The business researcher agent 204 then signals to the orchestrator module 116 that it has completed its process and the orchestrator module 116 calls the brand tone and visual agent 210.

The brand tone and visual agent (brand agent) 210 interacts with the AI model 144 to rewrite the document content so that it aligns with voice and visual style guides such as fonts, colors, and spacing. The brand agent 210 then signals to the orchestrator module 116 that it has completed its process. The orchestrator module 116 then calls the audience experience agent 226.

The audience experience agent 226 interacts with the AI model 144 to rewrite the document content. The audience experience agent 226 interacts with the AI model 144 to perform a relevance and value analysis, refines the tone and vocabulary of the document, and updates the document text to enhance impact on the readers. Adjusting language in documents so it is more engaging is important to enhance connection with the audience, increase engagement through more language that resonates emotionally, persuade and influence the audience, and make the document easier to understand. The audience experience agent 226 generates a prompt to the AI model 144, including a description of the desired persona (e.g., an AI language module specialized in text analysis and emotional engagement); a description of the task (e.g., to analyze the provided text and to modify the text to make the language more emotionally engaging); and a set of rules that the AI model 144 must follow in completing the tasks. Example rules include maintaining the original meaning and intent of the text, using vivid and descriptive language, incorporating sensory details and emotive expressions, ensuring text clarity, avoiding overuse of dramatic language, and respecting the tone and style unless otherwise specified. The prompt may be generated automatically via script by the audience experience agent 226 or may be generated by the audience experience agent 226 via a chat interface. For example, the chat interface may request user input on interests and needs of the audience. In response to the prompt, the AI model 144 rates each paragraph and summarizes the paragraphs based on interest level. The AI model 144 also suggests changes to the content to include the vocabulary and tone that would be common to the identified audience. The AI model 144 returns the modified text to the audience experience agent 226. The audience experience agent 226 signals to the orchestrator module 116 when its process is complete, and the orchestrator module 116 calls the editor agent 212.

The editor agent 212 interacts with the AI model 144 to rewrite the document content. For example, the editor agent 212 generates one or more prompts to the AI model 144 including text of the document, which the AI model 144 responds to with revised text. The prompts could include a string of text from the document with instructions to correct grammatical errors and misspellings, change passive voice to active voice, eliminate redundant words or phrases, and/or define key points for improving the flow the document. The AI model 144 analyzes and changes the text based on the prompts and responds to the prompts with modified text. The editor agent 212 signals to the orchestrator module 116 when its process is complete, and the orchestrator module 116 calls the anonymizer agent 230.

The anonymizer agent 230 interacts with the AI model 144 to analyze the document content and redact specific items. More specifically, the anonymizer agent 230 interacts with the AI model 144 to recognize named entities and replaces the names with anonymized descriptors. For example, original text located and incorporated by the document searcher agent 206 and/or the business researcher agent 204 may include the name of entities that should be removed based on guidance and/or policy. The anonymizer agent 230 generates a prompt including a persona, a task, rules, and output format. An example persona for the AI model 144 is that of an analysis and confidentiality expert with the primary goal of identifying, e.g., named client entities within the document and replacing the names with generic phrases to protect confidentiality. An example task is to perform the search and replace analysis and to ensure that the context and readability of the document is maintained, while making it impossible for someone to reasonably identify the named entity. Example rules could include that the original meaning and intent of the document are maintained, that the document remains clear and coherent, and that the tone and style of the document are maintained. The anonymizer agent 230 generates and sends the prompts to the AI model 144 along portions or the entirety of the text of the document. The AI model 144 analyzes and changes the text based on the prompts and responds to the prompts with modified text. The anonymizer agent 230 signals to the orchestrator module 116 when its process is complete, and the orchestrator module 116 calls the brand compliance agent 218.

The brand compliance agent 218 interacts with the AI model 144 to rewrite the document content based on brand guidelines or policies documented in brand books, style guides or brand associations for example. The brand compliance agent could replace passive grammatical constructions in the document with active tone to convey a more proactive and energetic attitude. The brand compliance agent 218 signals to the orchestrator module 116 when its process is complete, and the orchestrator module 116 calls the bias detector agent 214.

The bias detector agent 214 interacts with the AI model 144 to analyze the document text for bias based including, for example, gender bias, racial and cultural bias, age bias, stereotyping, underrepresentation, tokenism, and cognitive bias. For example, the bias detector agent 214 may generate one or more prompts to the AI model 144 including text of the document, to which the AI model 144 responds with revised text. The prompts could include a string of text from the document, a specified persona, instructions, and examples of text with identified biases and replacement instructions. The persona could include details such as the AI model's role as a risk professional. The instructions could be for the AI model 144 to consider a variety of examples of the bias listed above and to revise the text to remove any biases detected. The AI model 144 analyzes and changes the text based on the prompts and responds to the prompts with modified text. The bias detector agent 214 may then signal to the orchestrator module 116 when its process is complete, and the orchestrator module 116 calls the text regenerator agent 220.

The text regenerator agent 220 interacts with the AI model 144 to rewrite the document content based on rules. More specifically, the text regenerator agent 220 may prompt the AI model 144 to edit, resize, and rephrase text to ensure clarity and impact by ensuring the document fits within a desired wordcount or character count, either of which may be dictated by policy, document sizing rules, of by user specifications, all of which is given to the agent as run parameters. The AI model 144 analyzes the document based on the run parameters and realigns the text accordingly. The text regenerator agent 220 may then signal to the orchestrator module 116 when its process is complete, and the orchestrator module 116 calls the audio processor agent 222.

The audio processor agent 222 interacts with the AI model 144 to write a dialog script based on a list of questions. More specifically, the audio processor agent 222 may facilitate a two-way conversation with a user and capture and transcribe the conversation. The questions asked by the audio processor agent 222 may focus on details about the topic of the document and additional follow-up questions. The audio processor agent 222 may send audio clips of the conversation to the AI model 144 as part of a prompt for the AI model 144 to analyze and transcribe the audio clips and to incorporate the transcription into the document. The AI model 144 analyzes and changes the text based on the prompts and responds to the prompts with modified text. The audio processor agent 222 may then signal to the orchestrator module 116 when its process is complete, and the orchestrator module 116 calls the reviewer agent 216.

The approver agent 232 defines human reviewers, initiates notifications to the reviewers, and tracks their review status. In a first process, the approver agent 232 adds an approval task to an approval queue. The approver agent 232 sends a system reference of the document to be approved (e.g., an identification number) to a graph API to facilitate checking tasks and/or calendars of identified approvers. The approver agent 232 adds names, messages, task identifiers, etc. to an approval queue specific to the document. The approval queue may be stored in the long-term memory 134, for example, and referenced and/or modified as the queue is processed. In a second process, the approver agent 232 processes the approval queue for the identified document. The approver agent 232 may generate a record in the long-term memory 134 for each approver including, for example, a reference to the document, the approver ID and/or email address, a date and time the queue's creation, the current status of the approval, the approver's name, and a JSON message containing text for use in emails, etc. For each approver the approver agent 232 generates an email using the stored record. This may be done sequentially or serially. During the process, the approver agent 232 uses a timer function to measure the time to approval from instantiation of the request, which may be limited to a specified number of days, for example. If the timer expires, a third process is started wherein the approver agent 232 refers again to the stored record and generates an email or other message to notify the approver that a task awaits. The second notification may also be sent to an escalation point, which may also be identified in the stored record. A fourth process by the approver agent 232 is to receive an approval, denial, or request for more information from an approver. The approver agent 232 updates record in the long-term memory 134 for the specified document to reflect the status and includes any comments made by the approver. The document owner is then notified of the updated record, e.g., in an email that includes whether the document was approved, denied, or if more information was requested.

The designer agent 224 interacts with the AI model 144 to analyze the layout of the document created in the presentation format chosen by the user. Available presentation formats may include, but are not limited to, Microsoft Word files, Adobe PDF files, Microsoft PowerPoint files, Google slides, or any other suitable file. Based on the latest presentation design trends at the time of review, the agent may suggest modifications to the layout so the final document generated by the overall process can enhance engagement, convey a sense of modernity, and improve the overall user experience, ultimately making the document more effective and impactful.

As described above, the orchestrator module 116 leads the overall process, plans tasks, assigns subtasks, monitors progress, and recovers errors. The orchestrator module 116 may leverage the reviewer agent to monitor the tasks completed by other agents against the document and suggests further changes if it hasn't reached a satisfactory standard based on predetermined guidelines.

### Device Architecture

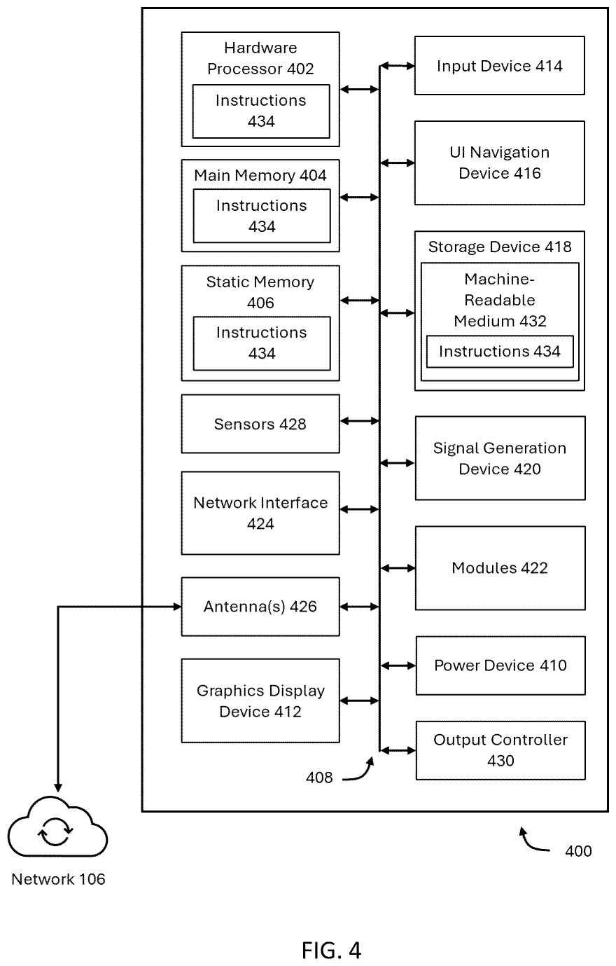

FIG. 4 is a block diagram of an example device 400 (e.g., the orchestrator device 130 or agent devices 102 of FIG. 1) or system upon which any of the techniques and processes discussed herein may be performed. In a networked environment, the device 400 may operate in the capacity of a server, a client, or both in a server-client network environment. In an example, the device 400 may act as a peer machine in Wi-Fi direct, peer-to-peer, or other distributed network environments. The device 400 may be a server, a docker container, a personal computer, a tablet, a set-top box, a personal digital assistant, a mobile telephone, a smartphone, a wearable computer device, a web appliance, or any device capable of executing instructions (sequential or otherwise) that specify actions to be taken by that device. While only a single device is illustrated in FIG. 4, the term “device” shall also be taken to include any collection of devices that individually or jointly execute a set of instructions to perform any of the methods or processes described herein, such as cloud computing, software as a service, or other computer cluster configurations.

Examples as described herein may include or operate on logic or a number of components, modules, or mechanisms. Modules are tangible entities (e.g., hardware) capable of performing specified functions when operating. A module includes hardware, which may be specifically configured to carry out a specific operation, or may include configurable parts, and a computer-readable medium containing instructions that cause the module to carry out a specific operation.

The device 400 may include a hardware processor 402 (e.g., a processing unit or chip, a graphics processing unit, a hardware processor core, or any combination thereof), a main memory 404, and a static memory 406, all communicatively coupled via a bus 408. The device 400 may also include a power management device 410, a graphics display device 412, one or more input devices 414, and one or more UI navigation devices 416. The input device 414 and navigation device 416 may be integrated such as through a touch screen, for example, or may be independent of each other. The device 400 may further include a storage device 418, a signal generation device 420 such as an emitter or speaker, one or more modules 422, a network interface device 424 or transceiver coupled to one or more antennae 426, and one or more sensors 428 (e.g., a global positioning system sensor, a compass, an accelerometer, etc.). The device 400 may include an output controller 430, such as a serial connection to communicate with or control one or more peripheral devices (e.g., a printer, a card reader, etc.)).

The storage device 418 may include a machine-readable medium 432 on which is stored one or more sets of data structures and/or instructions 434 (e.g., software) embodying by any of the methods or processes described herein. The instructions 434 may also reside, at least partially, within the main memory 404 or the static memory 406. Alternatively, the storage device 418 may constitute machine-readable media.

The modules 422 may carry out or perform any of the methods or processes described above (e.g., method 300 of FIG. 3). The modules 422 may be included in the agent device 102, e.g., as or including the information retrieval module 114, content creation module 110, automation module 118, decision support module 112 and orchestrator module 116.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to ROM, RAM, magnetic disk storage media, optical storage media, a flash memory, etc.

The term “machine-readable medium” may include any medium that is capable of storing, encoding, or carrying instructions for execution by the device 400 and that cause the device 400 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices, like electrically programmable read-only memory or electrically erasable programmable read-only memory, and flash memory devices, magnetic disks, such as internal hard disks and removable disks, magneto-optical disks, and CD-ROM and DVD-ROM disks.

The instructions 434 may further be transmitted or received over a communications network 106 using a transmission medium via the network interface device/transceiver 424 utilizing any one of a number of transfer protocols such as frame relay, internet protocol, transmission control protocol, user datagram protocol, hypertext transfer protocol, etc. Example communications networks may include a local area network, a wide area network, a packet data network (e.g., the Internet), mobile telephone networks (e.g., cellular networks), plain old telephone (POTS) networks, wireless data networks, and peer-to-peer networks, among others.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed. It is understood that the above descriptions are for purposes of illustration and are not meant to be limiting.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A method for generating documents using multiple artificial intelligence (AI) agents, the method comprising:
ingesting and summarizing content from existing files using a file analyzer agent, wherein ingesting comprises converting one or more binary files into machine-readable representations stored in memory and generating vectorized summaries thereof;
generating a draft document based on the summarized content using a document writer agent, wherein the draft document is generated by sequentially applying a plurality of stored prompts to an AI model and aggregating resulting outputs into a structured document object;
refining the draft document to align with brand tone and visual style guides using a brand tone and visual agent and comprising programmatically comparing the structured document object against stored brand policy data and modifying the structured document object based on the comparison;
editing the draft document for grammatical accuracy and clarity using an editor agent;
detecting and mitigating biases in the draft document using a bias detector agent and comprising analyzing the structured document object using one or more bias detection rules learned by the AI model;
coordinating the activities of the AI agents using an orchestrator device, wherein coordinating the activities comprises:
controlling execution order of the AI agents based on completion signals received from preceding agents;
storing intermediate outputs of the AI agents in memory for use as inputs to subsequent agents; and
managing inter-agent communication using a communications device for facilitating data exchange between the orchestrator device, the AI agents, and one or more user computing devices.

2. The method of claim 1, further comprising translating the draft document by generating a second structured document object in a target language using a translator agent.

3. The method of claim 1, further comprising recognizing named entities in the structured document object and replacing the named entities with anonymized descriptors using an anonymizer agent.

4. The method of claim 1, further comprising monitoring tasks completed by the AI agents and suggesting changes for compliance using a reviewer agent.

5. The method of claim 1, further comprising analyzing the structured document object and providing alternative phrases to adhere to brand compliance guidelines using a brand compliance agent.

6. The method of claim 1, further comprising performing relevance and value analysis, refining tone and vocabulary, and updating the structured document object text to enhance reader impact on the readers using an audience experience agent.

7. The method of claim 1, wherein the AI agents are selectively activated by the orchestrator device based on document metadata, user input or execution state data.

8. The method of claim 1, further comprising storing the ingested content and the structured document object as training or fine-tuning data for the AI model.

9. A system for generating documents using multiple artificial intelligence (AI) agents, the system comprising:
an AI model;
a plurality of AI agents stored in an AI agent library and configured to interact with the AI model the plurality of AI agents comprising:
a file analyzer agent configured to ingest content from existing files by converting binary files into vectorized representations and generating summaries thereof;
a document writer agent configured to generate structured document object by sequentially applying stored prompts to the AI model;
a brand tone and visual agent configured to modify the structured document object based on stored brand policy data;
an editor agent configured to edit the structured document object for grammatical accuracy and clarity; and
a bias detector agent configured to analyze the structured document object using bias detection rules learned by the AI model;
an orchestrator device configured to coordinate activities of the plurality of AI agents, the orchestrator device comprising:
a content creation module configured to manage and modify structured document objects stored in memory;
a decision support module configured to guide an approval process for generated documents;
an information retrieval module configured to ingest and summarize content from existing files by generating vectorized representations consumable by the AI model;
an automation module configured to perform automated services including translation and anonymization; and
a communications device configured to facilitate data exchange between the orchestrator device, the plurality of AI agents, and one or more user computing devices; and
one or more agent devices each comprising:
a processor for executing instructions;
short-term memory for storing program instructions and intermediate data;
long-term memory for storing data and applications;
an input module for accepting data as parameters;
an output module for delivering data as a result of execution.

10. The system of claim 9, wherein the AI model is a generative AI model capable of producing human-like text and realistic images.

11. The system of claim 9, further comprising a translator agent configured to generate a translated structured document object into one or more target languages.

12. The system of claim 9, further comprising an anonymizer agent configured to recognize named entities in the structured document object and replace the named entities with anonymized descriptors.

13. The system of claim 9, further comprising a reviewer agent configured to monitor tasks completed by other AI agents and suggest changes for compliance.

14. The system of claim 9, further comprising a brand compliance agent configured to analyze the structured document object and provide alternative phrases to adhere to brand compliance guidelines.

15. The system of claim 9, further comprising an audience experience agent configured to perform relevance and value analysis, refine tone and vocabulary, and update the structured document object to enhance reader impact.

16. The system of claim 9, wherein the orchestrator device is configured to selectively activate the plurality of AI agents based on user input, document parameters, or execution state data.

17. A system for orchestrating multiple artificial intelligence (AI) agents to generate documents, the system comprising:
an orchestrator device communicatively coupled to one or more user computing devices via a network, the orchestrator device comprising;
a content creation module configured to generate and refine structured document objects;
a decision support module configured to guide an approval process of generated documents;
an information retrieval module configured to ingest and summarize content from existing files by generating machine-readable representations;
an automation module configured to perform automated services including translation and anonymization; and
an orchestrator module configured to control execution order of multiple AI agents, manage inter-agent dependencies, store intermediate agent outputs in memory, and provide the stored outputs as inputs to subsequent AI agents.

18. The system of claim 17, wherein the orchestrator device further comprises a communications device configured to facilitate data exchange between the orchestrator device, the AI agents, and one or more user computing devices, including transmission of intermediate agent outputs and execution state data.

19. The system of claim 17, wherein the orchestrator module is configured to selectively activate AI agents based on one or more of user input, document metadata, or execution state data generated during execution of previously activated AI agents.

20. The system of claim 17, wherein the orchestrator module further comprises a feedback mechanism configured to store input data and output data generated by the AI agents in memory as training or fine-tuning data for an AI model.
